(19) United States
(12) Patent Application Publication
(10) Pub. No.: US 2017/0354943 A1
(43) Pub. Date: Dec. 14, 2017

(54) Container

(71) Applicant: Glabete GmbH, Ebersbach (DE)

(72) Inventor: Markus Hardegen, Esslingen (DE)

(21) Appl. No.: 15/599,538

(22) Filed: May 19, 2017

(30) Foreign Application Priority Data
May 20, 2016 (EP) 16170707.0

(51) Int. Cl. B01F 15/04; B01F 3/08; B01F 15/00; B01F 5/06; B01F 3/10; B01F 15/02

(52) U.S. Cl. CPC B01F 15/0495; B01F 3/10; B01F 15/0256; B01F 15/0087; B01F 15/0237; B01F 5/0614; B01F 3/0861; B01F 2215/006

(57) ABSTRACT

A container with two inner chambers (6, 7) running in its longitudinal direction and separated by at least one partition wall. An aerobic adhesive is stored in one inner chamber (6). A hydrophilic, gel-like activator is stored in the other inner chamber (7); a mixing unit can be attached to the front end of the container. The aerobic adhesive is fed to the mixing unit from the first inner chamber (6), and the hydrophilic activator is fed to the mixing unit from the second inner chamber (7), in a specified mixing ratio via a supply device and mixed together there. This mixture is discharged via an outlet opening (13) of the mixing unit.

### CROSS REFERENCE TO RELATED APPLICATIONS

This application claims the priority of DE 16170707.0 filed on 2016 May 20; this application is incorporated by reference herein in its entirety.

### BACKGROUND

The invention relates to a container.

The container to which the invention relates specifically serves to make a fastening agent available comprised of an aerobic adhesive and a hydrophilic activator.

A fastening agent of that type is known from WO 2009/156 013 A1. The fastening agent described there is comprised of a mixture of an aerobic adhesive and a hydrophilic activator; moisture is supplied in a regulated manner to the hydrophilic activator. The hydrophilic activator ensures that the entire volume of the aerobic adhesive can cure.

The aerobic adhesive and a hydrophilic substance are stored in separate containers in this system. To provide the fastening agent, an aerobic adhesive is put into a tray from a first container. The hydrophilic substance is then put into the tray from the second container. These components are then mixed together by an operator with a spatula to get the fastening agent. The spatula is moistened in the process so that liquid is supplied to the components in a regulated way and the fastening agent can cure. This fastening agent can then be used to fasten an object to a base.

A disadvantage here is that the mixing process for blending the aerobic adhesive with the hydrophilic substance and the regulated supply of moisture involve several work steps, so the provision of the fastening agent is relatively time-consuming.

A further drawback of this system is that a precise, reproducible specification of a mixing ratio of the aerobic adhesive and the hydrophilic substance is not possible or is only possible with great effort. To this end, the operator would have to push precisely measured quantities of the aerobic adhesive out of the first container and, moreover, push precisely measured quantities of the hydrophilic substance out of the second container, which is nearly impossible without additional measuring equipment.

On the contrary, the quantities of the aerobic adhesive and the hydrophilic substance that are taken from the two containers typically involve substantial degrees of imprecision because of estimations of the operator, so a reproducible specification of certain mixing ratio is not possible. But the fastening agent that is provided in this way will therefore also not have defined characteristics, especially with regard to the curing process and its adhesive properties.

### SUMMARY

The invention relates to a container with two inner chambers (6, 7) running in its longitudinal direction and separated by at least one partition wall. An aerobic adhesive is stored in one inner chamber (6). A hydrophilic, gel-like activator is stored in the other inner chamber (7); a mixing unit can be attached to the front end of the container. The aerobic adhesive is fed to the mixing unit from the first inner chamber (6), and the hydrophilic activator is fed to the mixing unit from the second inner chamber (7), in a specified mixing ratio via a supply device and mixed together there. This mixture is discharged via an outlet opening (13) of the mixing unit.

### DETAILED DESCRIPTION

The invention is based on the objective of designing a container of the type mentioned at the outset in such a way that provision of a fastening agent with reproducible characteristics is made possible.

The elements of claim 1 are specified to solve this problem. Advantageous embodiments and useful design developments of the invention are described in the dependent claims.

The invention relates to a container with two inner chambers running in its longitudinal direction and separated by at least one partition wall. An aerobic adhesive is stored in one inner chamber. A hydrophilic, gel-like activator is stored in the other inner chamber; a mixing unit can be attached to the front end of the container. The aerobic adhesive is fed to the mixing unit from the first inner chamber, and the hydrophilic activator is fed to the mixing unit from the second inner chamber, in a specified mixing ratio via a supply device and mixed together there. This mixture is discharged via an outlet opening of the mixing unit.

An assembly set, via which a mixture of an aerobic adhesive and a hydrophilic activator is automatically created in a single work step, is provided with the container as per the invention. The fastening agent that is formed in this way can be directly used to attach two objects of any shape.

An important aspect of the invention is that the aerobic adhesive and the hydrophilic activator are stored in separate inner chambers of the container with complete separation from one another. The aerobic adhesive and the hydrophilic activator are each available in a flowable form here, because the aerobic adhesive is available in an uncured form in the first inner chamber and a gel-like hydrophilic activator is stored in the second inner chamber.

An operator only has to actuate a supply device at the rear end to mix the components stored in the inner chambers with one another. Both the aerobic adhesive stored in the first inner chamber and the hydrophilic activator stored in the second inner chamber are fed to the mixing unit by the supply device, in particular via the generation of mechanical pressure. The aerobic adhesive and the hydrophilic activator are automatically mixed in the mixing unit; the mixing unit is advantageously designed in such a way that there is complete mixing of the aerobic adhesive and the hydrophilic activator. The mixture that is formed in this way is discharged through the outlet opening of the mixing unit and is then immediately available as ready-to-use fastening agent with which two objects can be joined to one another.

What is important in connection with this is that the container with its components, in particular the design of the inner chambers and the supply device, ensure that the aerobic adhesive and the hydrophilic activator are always fed to this mixing unit in the same mixing ratio when the supply device is actuated. A reproducible, ideal mixing ratio that guarantees complete curing of the aerobic adhesive via the addition of a regulated quantity of the hydrophilic activator is therefore solely determined by the container. Ideal and reproducible adhesive characteristics of the fastening agent made up of the aerobic adhesive and the hydrophilic activator are therefore obtained.

In accordance with an advantageous embodiment of the invention, the aerobic adhesive is comprised of silane polymers or of polyurethane.

As a further advantage, the hydrophilic activator is comprised of cotton, cellulose, a fiber composite material, a salt, a mineral, a resin, glycerin or propylene glycol.

Since the hydrophilic activator is available in a gel-like form in the inner chamber, the hydrophilic activator can advantageously contain moisture, in particular water or isopropanol.

The inner chambers of the container advantageously form channel-shaped structures that essentially extend over the entire length of the container.

In accordance with a first design variant, the inner chambers are arranged next to one another.

Alternatively, a central first inner chamber is provided that is surrounded by the second inner chamber.

In accordance with an advantageous embodiment of the invention, the container is designed in the form of a tube whose external wall is flexible.

In this case, the supply device is comprised of a tube squeezer at the rear end of the tube.

The rear end of the tube can be rolled up in a familiar way with the tube squeezer causing a uniform pressure to be created on the aerobic adhesive in the first inner chamber and the hydrophilic activator in the second inner chamber, which leads to the aerobic adhesive and the hydrophilic activator to be fed into the mixing unit in a specified mixing ratio.

In accordance with a second advantageous embodiment of the invention, the container is designed in the form of a cartridge.

The supply device is comprised of at least one piston at the rear end of the cartridge.

A defined pressure that leads to the aerobic adhesive and the hydrophilic activator being fed into the mixing unit in a specified mixing ratio is exerted by the piston or pistons on both the aerobic adhesive in the first inner chamber and the hydrophilic activator in the second inner chamber.

In accordance with an advantageous embodiment, the mixing unit is a static mixer that has a mixing tube and a mixing spiral.

A complete mixture of the aerobic adhesive and the hydrophilic activator that are fed into the static mixer from the inner chambers can be carried out in a simple way with this static mixer. A complete mixture is achieved here with a sufficiently long mixing spiral, because the components that were separated at the beginning, meaning the aerobic adhesive and the hydrophilic activator, are further mixed with each revolution of the mixing spiral.

In accordance with a further advantageous embodiment of the invention, a connecting segment is provided on the front end of the container to which the mixing unit can be fastened in a reversible and detachable manner.

In particular, the connecting segment has a housing; the mixing unit can be screwed onto it.

When the aerobic adhesive and the hydrophilic activator are fed from the inner chambers to the mixing unit via the actuation of the supply device to mix these components, most of the mixture produced in the mixing unit is in fact discharged through its outlet opening. But residues of the mixture typically remain in the mixing unit and cure there, so the mixing unit then becomes unusable. A mixing unit can be removed from the container after use and then replaced by a new mixing unit in order to deliver the aerobic adhesive and the hydrophilic activator from the container a multiple number of times and to be able to use it to produce the fastening agent.

### BRIEF DESCRIPTION OF THE DRAWINGS

The invention will be explained with the aid of the drawings below. The following are shown in the figures:

FIG. 1: First example of the container as per the invention.

FIG. 2: First embodiment of inner chambers for the container in accordance with FIG. 1.

FIG. 3: Second embodiment of inner chambers for the container in accordance with FIG. 1.

FIG. 4: Example of a mixing unit for the container as per the invention.

FIG. 5: Second example of the container as per the invention.

### DETAILED DESCRIPTION OF THE PREFERRED EMBODIMENTS

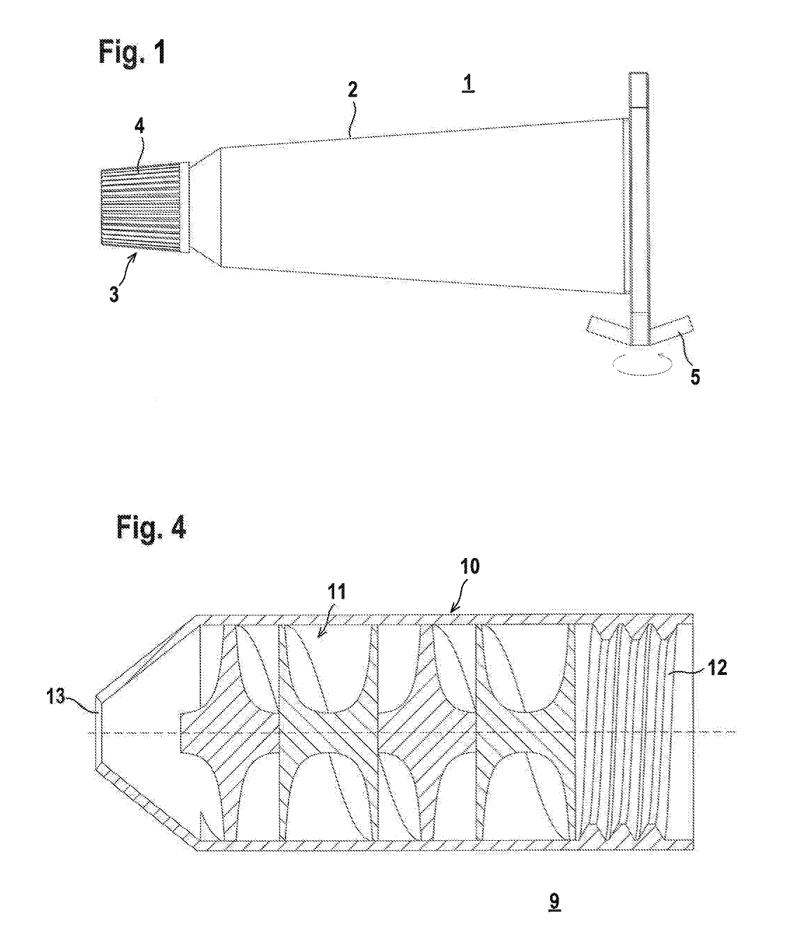

FIG. 1 shows a first example of the container as per the invention in the form of a tube 1. The tube 1 comprises, in a known fashion, a base body with a flexible external edge 2 that is made, for example, of a plastic that can undergo a reversible change in shape. A connecting segment 3 that essentially has a hollow cylindrical shape and is comprised of a rigid material with bending resistance, in particular a plastic material, is located at the front end of the tube 1. An external thread 4 is located on the outer surface. A tube squeezer 5 is located at the rear end of the tube 1.

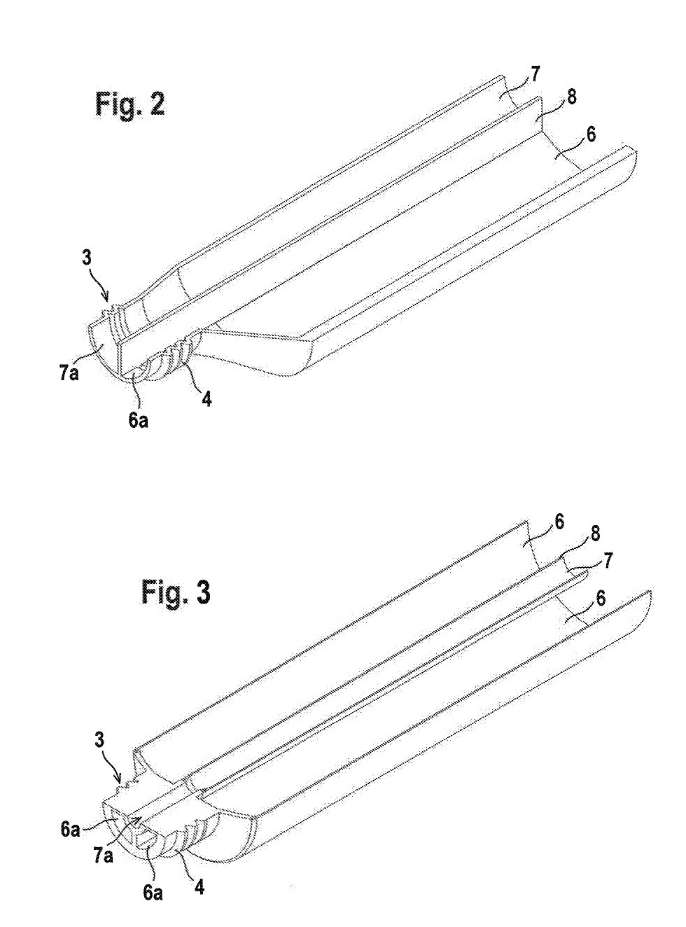

As per the invention, the interior of the tube 1 is divided up into two inner chambers 6, 7. FIG. 2 shows a first embodiment in which the two inner chambers 6, 7 are arranged next to one another. FIG. 3 shows a second embodiment with two coaxial inner chambers 6, 7, meaning that a first inner chamber 6 surrounds a second, central inner chamber 7.

The inner chambers 6, 7 run parallel to one another in the longitudinal direction of the tube 1 in both embodiments. The inner chambers 6, 7 are completely separated from one another via walls 8 here. Each inner chamber 6, 7 extends over the entire length; especially the inner chambers 6, 7 in the area of the connecting segment 3 form outlet areas 6a, 7a that are separated by the walls 8. Different materials are thereby stored with complete separation from one another in the inner chambers 6, 7 with their outlet areas 6a, 7a.

As per the invention, an aerobic adhesive is stored in the first inner chamber 6. A hydrophilic activator is stored in the second inner chamber 7.

The aerobic adhesive is made up of a silane polymer or polyurethane. The aerobic adhesive is available in an uncured form in the first inner chamber 6 and therefore in a flowable form.

A hydrophilic activator that comprises a reaction accelerator in general that accelerates the curing of the aerobic adhesive when the hydrophilic activator is mixed together with the aerobic adhesive is stored in the second inner chamber 7.

The hydrophilic activator is available in a gel-like and therefore a flowable form in the second inner chamber 7. The hydrophilic activator is advantageously comprised of cotton, cellulose, a fiber composite material, a salt, a mineral, a resin, glycerin or propylene glycol.

Moisture, especially water or isopropanol, is added to the hydrophilic activator, in particular in the case that the substances of the hydrophilic activator originally exist in a solid form, so the hydrophilic activator exists in a gel-like form.

A mixing unit is placed on the connecting segment 3 to provide a fastening agent by means of which two objects can be joined via a glue bond in a permanent and firm manner. FIG. 4 shows a mixing unit of that type in the form of a static mixer 9.

The static mixer 9 is comprised of a mixing tube 10 and a mixing spiral 11 that is mounted in the mixing tube 10 and that extends in its longitudinal direction. In the present case, the mixing spiral 11 has four spiral segments that are connected to one another in the axial direction. In general a different, in particular larger, number of spiral segments can also be provided. A thread 12 that can be screwed onto the external thread 4 of the connecting segment of the container, causing a reversible and detachable connection to arise between the container and the static mixer 9, is located at the rear end of the static mixer 9. The front end of the static mixer 9 is designed in the form of a tip; an outlet opening 13 is provided at its front end.

To provide the fastening agent, the tube squeezer 5 is turned, meaning in general that the supply device is actuated, causing a pressure to be exerted starting from the rear end of the tube 1 on both the aerobic adhesive in the first inner chamber 6 and on the hydrophilic activator in the second inner chamber 7. Both the aerobic adhesive and the hydrophilic activator are fed to the static mixer 9 from the two inner chambers 6, 7 because of this pressure. The design of the supply device in the form of the tube squeezer 5 that exerts a uniform pressure on the aerobic adhesive in the first inner chamber 6 and on the hydrophilic activator in the second inner chamber 7 and the specific geometric design of the inner chambers 6, 7 ensure that the aerobic adhesive and the hydrophilic adhesive are fed to the static mixer 9 in a defined, constant mixing ratio.

The aerobic adhesive and the hydrophilic activator are brought, as a result of the pressure exerted by the tube squeezer 5, one after the other through the individual spiral segments of the mixing spiral 11 in the static mixer 9. There is always a stronger and stronger mixing of the two components from one spiral segment to the next. The number of spiral segments is chosen in such a way that the aerobic adhesive and the hydrophilic activator are completely mixed together at the end of the mixing spiral 11. The fastening agent that is formed in this way is then discharged from the static mixer 9 through the outlet opening 13 and can then be used to attach two objects.

After use of the static mixer 9, it is unscrewed from the container again. A new static mixer 9 is screwed onto the connecting segment of the container as soon as the container is required from anew to provide the fastening agent.

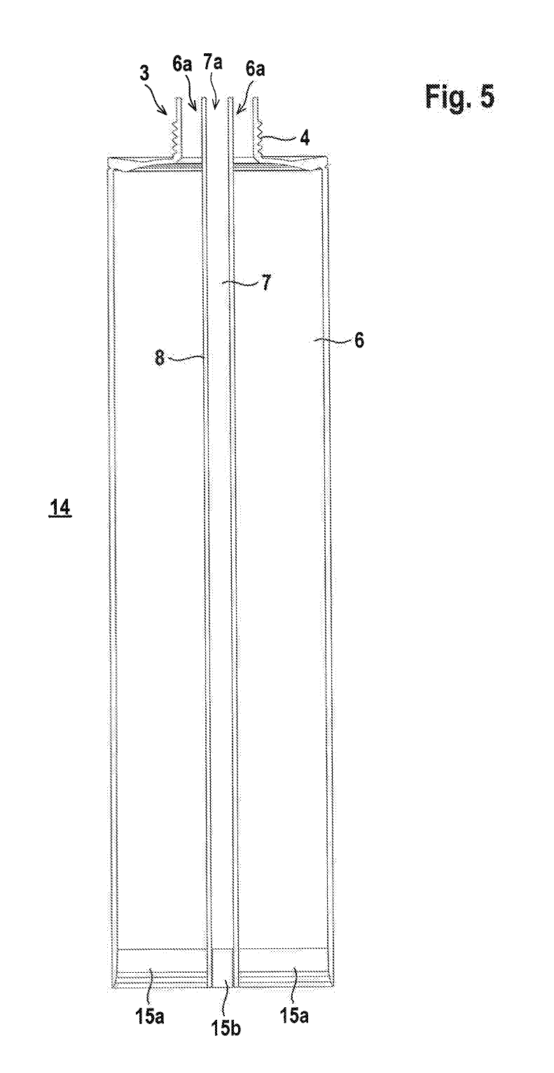

FIG. 5 shows a second example of the container in the form of a cartridge 14. The cartridge 14 has, analogous to the embodiment of FIG. 2, two concentric inner chambers 6, 7 separated by a wall 8. In principle, inner chambers 6, 7 lying next to one another can also be provided.

Analogous to the embodiment of FIG. 1, a connecting segment 3 with an external thread 4 is provided at the front end of the cartridge 14. The inner chambers 6, 7 extend over the entire length of the cartridge 14 and are routed with their outlet areas 6a, 7a into the interior of the connecting segment 3.

Pistons 15a, 15b, as supply devices, are located at the rear end of the cartridge 14. Pressure is exerted on the aerobic adhesive stored in the first inner chamber 6 with the first piston 15a via an actuation device that is not shown. Correspondingly, pressure is exerted on the hydrophilic activator stored in the inner chamber 7 with the second piston 15b. The same pressure is preferably exerted on the two components. The aerobic adhesive and the hydrophilic activator correspond in terms of their design to the embodiment in accordance with FIG. 1.

In a further analogy to the embodiment in accordance with FIG. 1, the static mixer 9 according to FIG. 5 can be screwed onto the connecting segment 3 of the cartridge 14. The aerobic adhesive from the first inner chamber 6 and the hydrophilic activator from the second inner chamber 7 are then fed into the static mixer 9, where the mixture of these components takes place, via the exertion of pressure with the pistons 15a, 15b. The fastening agent that is formed in this way is discharged again from the outlet opening 13 of the static mixer 9.

### LIST OF REFERENCE NUMERALS

(1) Tube
(2) External wall
(3) Connecting segment
(4) External thread
(5) Tube squeezer
(6) Inner chamber
(6a) Outlet area
(7) Inner chamber
(7a) Outlet area
(8) Wall
(9) Static mixer
(10) Mixing tube
(11) Mixing spiral
(12) Thread
(13) Outlet opening
(14) Cartridge
(15a) Piston
(15b) Piston

1. Container with two inner chambers (6, 7) running in its longitudinal direction and separated by at least one partition wall, wherein an aerobic adhesive is stored in an inner chamber (6) and wherein a hydrophilic, gel-type activator is stored in the other inner chamber (7), wherein a mixing unit can be attached to the front end of the container and wherein the aerobic adhesive from the first inner chamber (6) and the hydrophilic activator from the second inner chamber (7) are supplied to the mixing unit in a specified mixing ratio via a supply device and mixed together there, and this mixture is output through an outlet opening (13) of the mixing unit.

2. Container according to claim 1, characterized in that the aerobic adhesive is comprised of silane polymers or of polyurethane.

3. Container according to claim 1, characterized in that the hydrophilic activator is comprised of cotton, cellulose, a fiber composite material, a salt, a mineral, a resin, glycerin or propylene glycol.

4. Container according to claim 1, characterized in that the hydrophilic activator contains moisture.

5. Container according to claim 4, characterized in that the moisture is comprised of water or isopropanol.

6. Container according to claim 1, characterized in that the mixing ratio of the aerobic adhesive to the hydrophilic activator is determined by the designs of the inner chambers (6, 7) and the supply device.

7. Container according to claim 1, characterized in that the inner chambers (6, 7) are arranged next to one another.

8. Container according to claim 1, characterized in that a central, second inner chamber (7) is provided that is surrounded by the first inner chamber (6).

9. Container according to claim 1, characterized in that it is a tube (1).

10. Container according to claim 9, characterized in that the supply device is comprised of a tube squeezer (5) at the rear end of the tube (1).

11. Container according to claim 1, characterized in that it is a cartridge (14).

12. Container according to claim 11, characterized in that the supply device is comprised of at least one piston (15a, 15b) at the rear end of the cartridge (14).

13. Container according to claim 1, characterized in that a connecting segment is provided at the front end of the container that the mixing unit can be attached to in a reversible and detachable manner.

14. Container according to claim 13, characterized in that the connecting segment has a housing such that the mixing unit can be screwed onto the housing.

15. Container according to claim 1, characterized in that the mixing unit is a static mixer (9) that has a mixing tube (10) and a mixing spiral (11).
